(19) United States
(12) Patent Application Publication
(10) Pub. No.: US 2015/0331916 A1
(43) Pub. Date: Nov. 19, 2015

(54) COMPUTER, DATA ACCESS MANAGEMENT METHOD AND RECORDING MEDIUM

(71) Applicant: HITACHI, LTD., Tokyo (JP)

(72) Inventors: Takaaki HARUNA, Tokyo (JP); Shoji KODAMA, Tokyo (JP); Go KOJIMA, Tokyo (JP); Nobumitsu TAKAOKA, Tokyo (JP)

(73) Assignee: Hitachi, Ltd., Tokyo (JP)

(21) Appl. No.: 14/427,949

(22) PCT Filed: Feb. 6, 2013
(86) PCT No.: PCT/JP2013/052662

§ 371 Date: Mar. 12, 2015

(51) Int. Cl. G06F 17/30

(52) U.S. Cl. CPC G06F 17/30563; G06F 17/30221; G06F 17/30345; G06F 17/30592

(57) ABSTRACT

A computer system including a shared file server manages the access to file data for performing access to the file data accurately and efficiently. This computer includes a plurality of first name spaces to which is assigned an access path to data stored in a storage area, and a name space to which is assigned a path corresponding to the access path and which is different from the first name spaces. When the access paths generated in different first name spaces are the same, the corresponding paths which correspond to the same access paths are changed into mutually different paths. Moreover, by assigning a path corresponding to the data to be analyzed, it is possible to efficiently access the requested data among a large amount of data. In addition, the sorting of the corresponding paths is changed according to the load of the computer storing the data.

### TECHNICAL FIELD

The present invention relates to a data access management method, a management apparatus and a recording medium storing a program in a shared file system which performs data transmission between computers.

### BACKGROUND ART

The data volume of digital data, particularly file data, that is managed in large-scale computer systems realized through recent cloud environments and big data processing is increasing rapidly. Thus, in addition to the method of simply increasing the number of physical computers configuring the system, a computer system which mutually coordinates servers that perform specific processing and outputs one processing result based on the virtualization technology has been realized.

This system may be configured from an ETL (Extract Transform Load) which collects predetermined data from a data source storing various data and generates processed data, a DWH (Data WareHouse) which generates processed data to become the source of search or analysis of the association between the processed data generated by the ETL, and an analytical functional unit such as a shared file server which manages the shared access to data stored in the DWH or a search server which searches or analyzes the processed data stored in the DWH and generates or analyzes the processed data.

A name space corresponding to each DWH is configured in the shared file server. While the DWH can access the name space that is correspondingly configured, it is unable to access a name space that is configured in correspondence to another DWH. Thus, when the analyzing server or search server is to access file data managed in another name space, adopted may be a method of changing the assignment of the name space of the DWH to another name space and realizing the access to the file data, or a method of replicating the file data, which is being managed in another name space, in a storage area of the name space that is assigned to the DWH connected to the host server.

Nevertheless, when a system is configured using numerous servers, prompt data processing cannot be realized since it will take forever to change the configuration of the system. Moreover, replication of the file data will result in the considerable increase in the processing load for performing the replication and the memory load for storing the file data.

Thus, known is a technique of using a stub as a method for efficiently accessing file data (PTL 1). PTL 1 discloses a technology of generating stubs of all file data stored in the DWH existing in the system, and accessing the file data that is being stored in a corresponding/non-corresponding name space.

### CITATION LIST

### Patent Literature

[PTL 1] International Publication No. 2012/035588

### SUMMARY OF INVENTION

### Technical Problem

Nevertheless, when integrating and managing the file data with one shared file system as with the technology described in PTL 1, it is not possible to efficiently perform appropriate access control to the file data. Specifically, when the name of a stub that was created for data access overlaps between different name spaces, a system that accesses file data from a name space having a small management number assigned to the name space is unable to access file data of a name space having a large management number.

### Solution to Problem

In order to resolve the foregoing problems, a representative aspect of the present invention is a computer including a plurality of first name spaces to which an access path to data stored in a storage area is assigned, and a name space to which a path corresponding to the access path is assigned and which is different from the first name spaces, wherein, when the access paths generated in different first name spaces are the same, the corresponding paths which correspond to the same access paths are changed into mutually different paths.

### Advantageous Effects of Invention

According to one aspect of the present invention, it is possible to efficiently access file data in a computer system including a shared file server.

### BRIEF DESCRIPTION OF DRAWINGS

FIG. 1 is a schematic diagram of a computer system as the first embodiment to which the present invention is applied.

FIG. 2 is a block diagram showing a configuration example of the computer system in the first embodiment.

FIG. 3 is a diagram showing an example of the stub 112 of the DWH 110 in the first embodiment.

FIG. 4 is a diagram showing an example of the NS list 160 of the shared file server 150 in the first embodiment.

FIG. 5 is a diagram showing an example of the file name correspondence table 170 of the shared file server 150 in the first embodiment.

FIG. 6 is a diagram showing an example of the file name change table 180 of the shared file server 150 in the first embodiment.

FIG. 7 is a flowchart showing an overall processing example in the first embodiment.

FIG. 8 is a flowchart showing the flow of the file name change processing that is executed by the file name management unit 152 in the first embodiment.

FIG. 9 is a flowchart showing the flow of the file name registration processing that is executed by the file name management unit 152 in the first embodiment.

FIG. 10 is a flowchart showing the flow of the file access processing that is executed by the access request relay unit 153 in the first embodiment.

FIG. 11 is a block diagram showing a configuration example of a computer system as the second embodiment to which the present invention is applied.

FIG. 12 is a diagram showing an example of the analytical range designation information 1302 in the second embodiment.

FIG. 13 is a diagram showing an example of the analyzing server list 1303 in the second embodiment.

FIG. 14 is a flowchart showing the flow of the file refinement processing that is executed by the analytical range management unit 1301 in the second embodiment.

FIG. 15 is a diagram showing an example of the refinement processing result 1304 of refining files, based on the analytical range designation information 1302, from the file data list before the file refinement processing in the second embodiment.

FIG. 16 is a diagram showing an example of the stub assignment result 1305 in the second embodiment.

FIG. 17 is a block diagram showing a configuration example of a computer system as the third embodiment to which the present invention is applied.

FIG. 18 is a diagram showing an example of the analyzing server management table 1702 in the third embodiment.

FIG. 19 is a diagram showing an example of the execution processing table 1703 in the third embodiment.

FIG. 20 is a flowchart showing the flow of the load redistribution processing that is executed by the load management unit 1701 in the third embodiment.

### DESCRIPTION OF EMBODIMENTS

### First Embodiment

The first embodiment to which the present invention is applied is now explained in detail with reference to the appended drawings. While the appended drawings illustrate specific embodiments and implementations in accordance with the principle of the present invention, the appended drawings are provided for facilitating the understanding of the present invention, and are not provided for limiting the interpretation of the present invention. The present invention covers the various modifications and equivalent configurations within the scope of the appended claims.

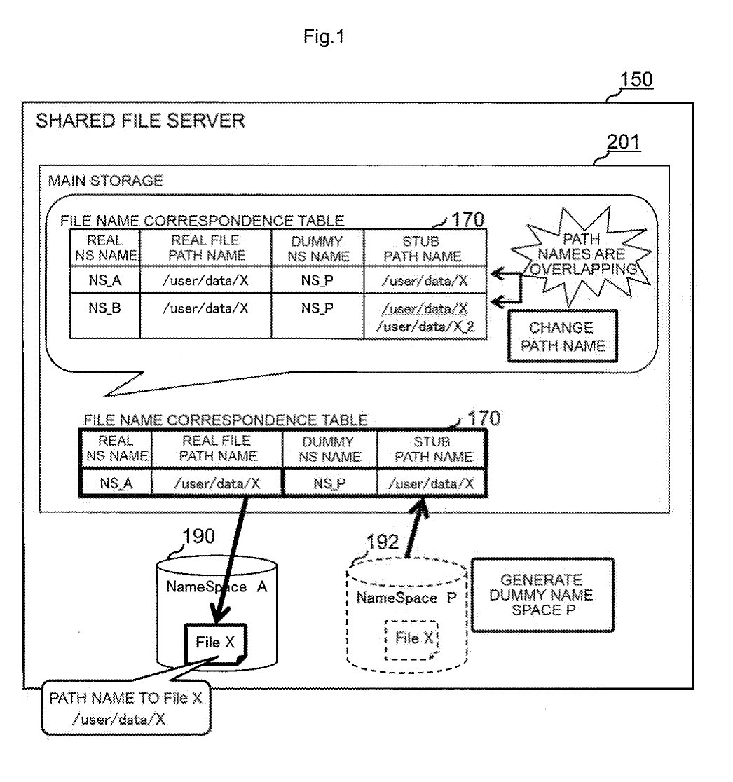

FIG. 1 explains the outline of this embodiment. In this embodiment, a dummy name space 192 corresponding to a DWH of an analyzing server is foremost generated. A dummy name space is a name space that does not actually store file data, but is conveniently created for accessing the name space storing data (hereinafter referred to as the “real name space”). Subsequently, an association of a real file path name for accessing the file data from the real name space 190 and a stub path name for accessing the file data from the dummy name space 192 is managed with the file name correspondence table 170 in the shared file server. In addition, when the real file path name and the stub path name overlap, the stub path name is changed in order to access the file data.

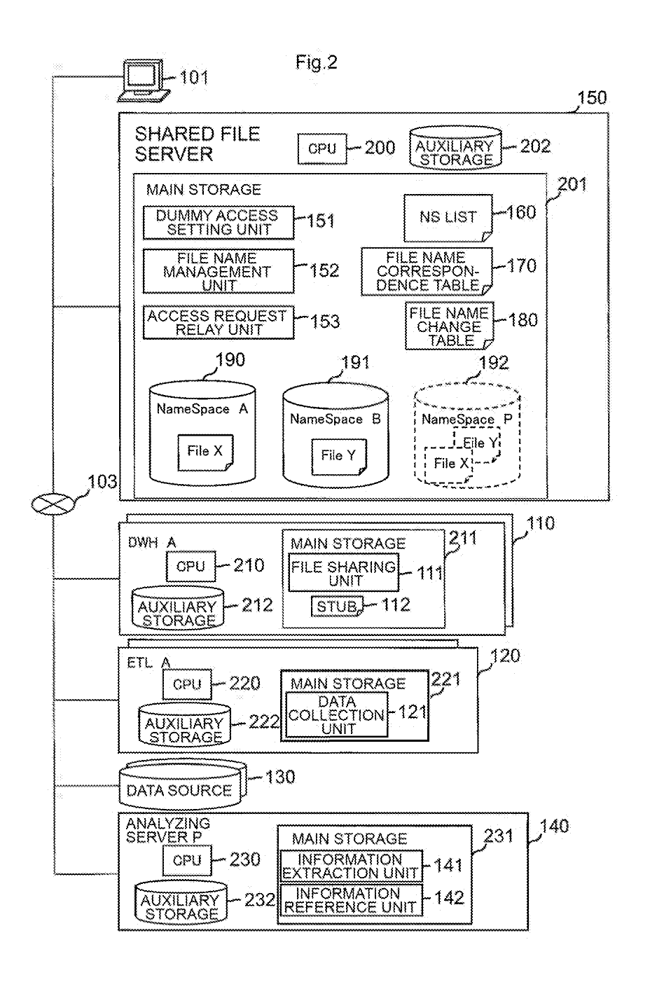

FIG. 2 shows a system configuration of the computer system in the first embodiment. The computer system includes a shared file server 150, a DWH 110, an ETL 120, a data source 130 and an analyzing server 140. The respective components are communicably connected via a wired or wireless network 103. A processing result is returned in response to the various requests sent from the client 101. The computer system is configured from a DWH 110, an ETL 120, a data source 130, an analyzing server 140 and a shared file server 150.

The data source 130 is a general purpose server apparatus, and is configured from a storage apparatus comprising one or more physical computers and an HDD, a SSD (Solid State Store) or the like. Structured data, semi-structured data, non-structured data and other data are stored in the storage apparatus by various external systems connected to the data source. The file data stored in the data source 130 is collected (crawled) in the ETL 120 based on a predetermined trigger, and subsequently crawled in the DWH 110 based on a predetermined trigger.

The ETL 120 is a server that collects (crawls) data from the data source 130 according to a schedule. The ETL 120 is configured from a CPU 220, a main storage 221 and an auxiliary storage 222, and a data collection unit 121 is realized through coordination with the programs stored in the CPU 220 and the main storage 221. The collected data is thereafter output to the DWH 110 according to a predetermined schedule. For example, the data collected by the ETL 120 is text data, image data and their metadata, and these data are processed into a predetermined data format.

The DWH 110 is a file server that crawls data from the ETL 120 according to a schedule and stores the crawled data in a file format. The DWH 110 is configured from a CPU 210, a main storage 211 and an auxiliary storage 212, and a file sharing unit 111 that provides a file sharing function to the analyzing server 140 is realized through coordination with the programs stored in the CPU 210 and the main storage 211, and enables access to the stored files. Moreover, the DWH 110 includes a stub 112. The stub 112 is used for accessing the file data stored in the shared file server 150.

The analyzing server 140 executes analytical processing to predetermined file data in accordance with a request from the client 101, and returns a processing result. The analyzing server 140 is configured from a CPU 230, a main storage 231 and an auxiliary storage 232, and an information extraction unit 141 and an information reference unit 142 are realized through coordination with the programs stored in the CPU 230 and the main storage. The analyzing server 140 reads data from the DWH 110 according to a schedule, analyzes the data content and stores the obtained information as metadata, and thereby enables referral to that information.

Specifically, the data content is analyzed by the information extraction unit 141, and a metafile is thereby generated. Moreover, the metafile generated by the information reference unit 142 can be referenced in response to a metafile reference request from the client.

The file data stored in the data source 130 is crawled in the ETL 120 based on a predetermined trigger, subsequently crawled in the DWH 110 at a scheduled time, and thereafter crawled in the analyzing server 140 at a predetermined time and then transmitted.

The shared file server 150 receives a request from the client 101 connected via the network 103 for changing the configuration information or changing the processing setting of the computer system. A name space corresponding to each DWH 110 is configured in the server. The shared file server 150 is configured from a CPU 200, a main storage 201 and an auxiliary storage 202, and various functional units such as a dummy access setting unit 151, a file name management unit 152 and an access request relay unit 153 are realized through coordination with the programs stored in the CPU 200 and the main storage 201.

The dummy access setting unit 151 generates, references, changes and deletes the dummy name space 192. Moreover, the dummy access setting unit 151 generates, changes and deletes the stub that refers to the dummy name space 192 in the shared file system. In addition, the association of the file name existing in the real name space and the file name of the dummy name space that is referenced using the stub is managed using the file name correspondence table 170.

The file name management unit 152 refers to the file name change table 180, and performs the processing of changing the stub path name.

The dummy access setting unit 151 performs access processing of accessing the file data.

The reference data of the shared file server 150 is now explained. Here, while the reference data is illustrated by adopting various table formats, the information to be managed is not limited to a table format.

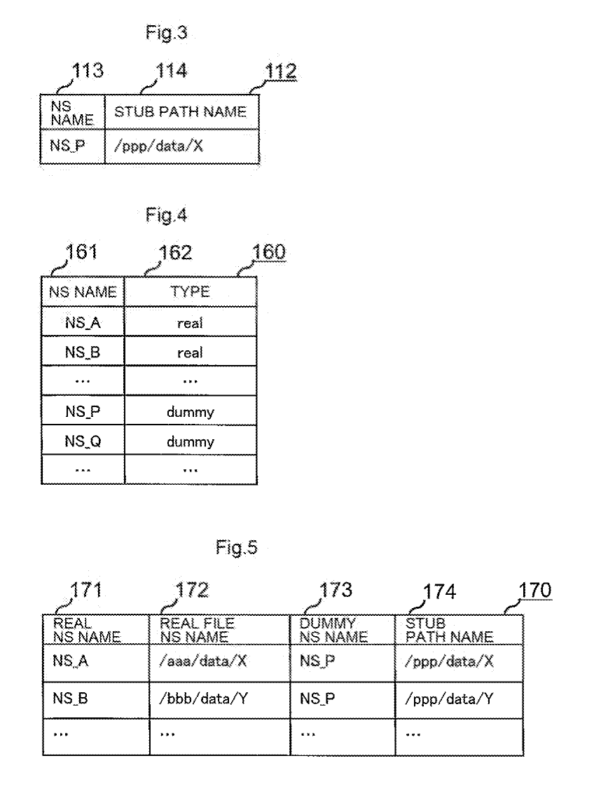

FIG. 3 shows the stub 112 of the DWH 110. The analyzing server 140 accesses the file data via the stub 112. The stub 112 is configured from an NS name 113 (the abbreviation of “NS” hereinafter refers to a name space) and a stub path name 114. The NS name 113 shows the name of the name space that the analyzing server 140 will access. The stub path name 114 shows the path name for accessing the actual file data.

FIG. 4 shows an NS list 160 of the shared file server 150. The file name management unit 152 refers to the NS list 160, and determines whether the name space that it is accessing is a real name space or a dummy name space.

The NS list 160 is configured from an NS name 161 and a type 162. The NS name 161 shows the name of the real name space and the dummy name space. The type 162 shows whether each name space is a real name space (real) or a dummy name space (dummy).

FIG. 5 shows a file name correspondence table 170 of the shared file server 150. The file name management unit 152 accesses the real file data by referring to the file name correspondence table 170. The file name correspondence table 170 shows the correspondence relation between the file path name of the real name space and the stub path name of the dummy name space, and includes a real NS name 171, a real file path name 172, a dummy NS name 173 and a stub path name 174.

The real NS name 171 shows the real name space storing actual data. The real file path name 172 stores the path name for accessing the name space. The dummy NS name 173 shows the name of the dummy name space. The stub path name 174 stores the stub path name for accessing the dummy name space.

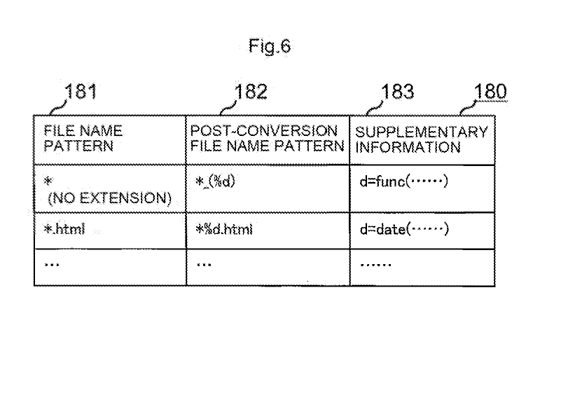

FIG. 6 shows a file name change table 180 of the shared file server 150. The file name management unit 152 determines a new stub path name by referring to the file name change table 180 when a stub path name overlaps between different name spaces.

The file name change table 180 is configured from a file name pattern 181, a post-conversion file name pattern 182 and supplementary information 183. The file name pattern 181 stores information related to a file extension. The post-conversion file name pattern 182 is information that is assigned to the file name after the file name conversion. The supplementary information 183 stores supplementary information related to the file data. For example, the supplementary information 183 stores the detailed information of the file name pattern.

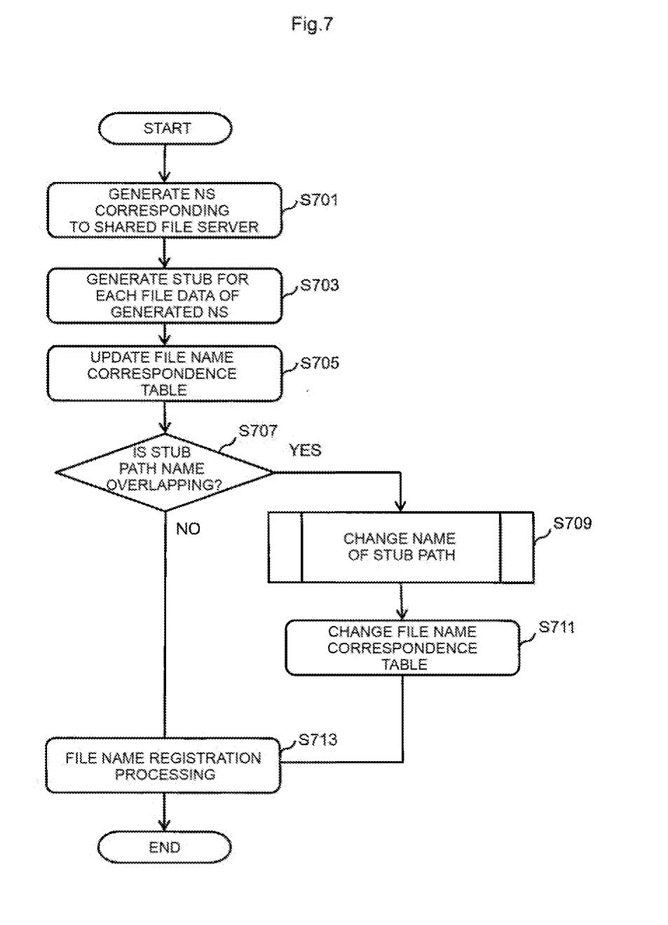

FIG. 7 is a flow showing the overall processing in the computer system of this embodiment.

Foremost, in S701, the dummy access setting unit 151 newly generates a name space corresponding to the shared file server 150.

Subsequently, in S703, the dummy access setting unit 151 generates a stub 112 for each file data that is being managed by the name space generated in S701, and sets a stub path name for accessing the actual data.

Subsequently, in S705, the dummy access setting unit 151 updates the file name correspondence table 170 (hereinafter referred to as the “file name update processing”).

In S707, the dummy access setting unit 151 determines whether the stub path name 174 of the file name correspondence table 170 is overlapping. When the stub path name 174 is overlapping (S707: Yes), the file name management unit 152 changes the file name in S709 (hereinafter referred to as the “file name change processing”). Subsequently, in S711, the file name management unit 152 changes and registers the file name correspondence table 170 (hereinafter referred to as the “file name registration processing”) (S713). When the file name is not overlapping (S707: No), the file name is registered as is and then the processing is ended.

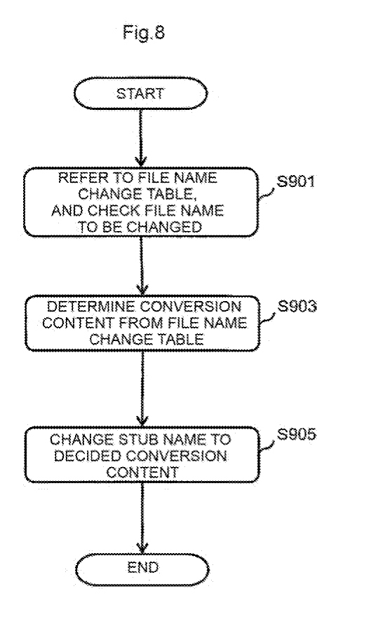

FIG. 8 shows the flow of the file name change processing (S104) that is executed by the file name management unit 152. This processing is processing of using the file name change table 180 to change the stub path name when the stub path name of the file name correspondence table 170 is overlapping between different name spaces.

Foremost, in S901, the file name management unit 152 refers to the file name change table 180, and identifies the file name to be changed and the file name pattern.

Subsequently, in S903, the file name management unit 152 determines the changes made to the file name from the post-conversion file name pattern 182 of the file name change table 180. Changes made to the file name are determined from the post-conversion file name pattern 181 of the file name change table 180.

Finally, in S905, the file name management unit 152 changes the stub path name to the determined changes.

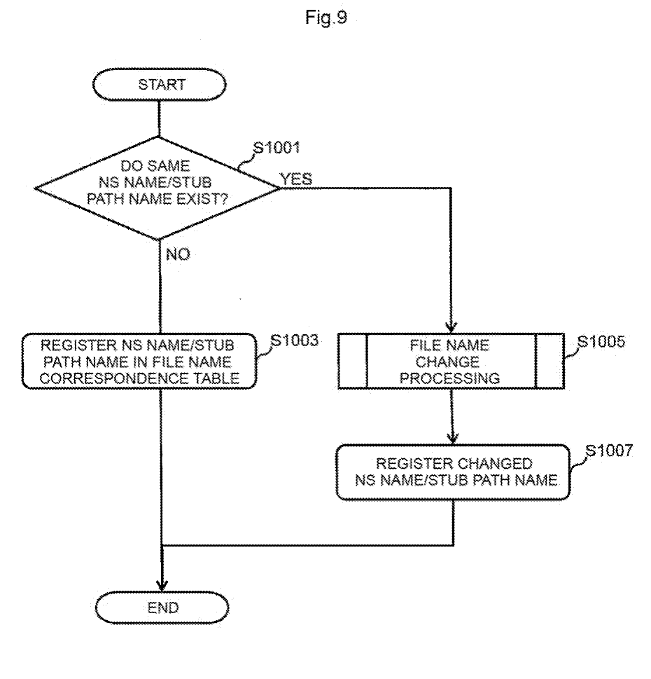

FIG. 9 shows the flow of the file name registration processing (S105) that is executed by the file name management unit 152. This processing is processing of registering the NS name and the stub path name in the file name correspondence table 170.

Foremost, in S1001, the file name management unit 152 determines whether the same dummy NS and stub path name exist in the file name correspondence table 170.

When the same stub path name does not exist (S1001: Yes), in S1003, the file name management unit 152 registers the NS name and stub path name in the file name correspondence table 170, and then ends the processing.

When the same stub path name does exist (S1001: No), in S1005, the file name management unit 152 performs the file name change processing. Subsequently, in S1007, the file name management unit 152 registers the changed NS name and stub path name, and then ends the processing.

The processing of accessing the file data (hereinafter referred to as the “file access processing”) is now explained.

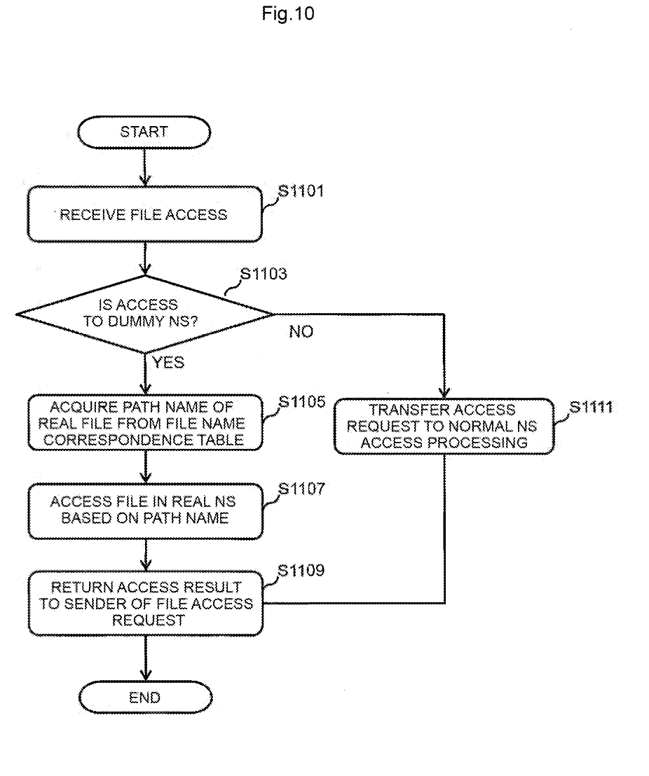

FIG. 10 shows the flow of the file access processing that is executed by the access request relay unit 153.

Foremost, in S1101, the access request relay unit 153 receives a file access request from a client.

Subsequently, in S1103, the access request relay unit 153 determines whether the received request is an access to the dummy name space by referring to the NS list 160.

When the received request is an access to the dummy name space (S1103: Yes), in S1105, the access request relay unit 153 acquires, from the file name correspondence table 170, the path name of the real file storing data.

Subsequently, in S1107, the access request relay unit 153 accesses the file based on the acquired path name.

Finally, in S1109, the access request relay unit 153 returns the accessed result in response to the file access request.

When the received request is not an access to the dummy name space (S1103: No), in S1111, the access request relay unit 153 transfers the access request to the normal name space access processing, and then ends the processing.

The first embodiment was explained above. According to this embodiment, the analyzing server can efficiently access appropriate file data by generating a dummy name space corresponding to the DWH of the analyzing server, and performing the change processing of the stub path name so that the stub name does not overlap between different name spaces.

### Second Embodiment

The second embodiment of the computer system to which the present invention is applied is now explained. The second embodiment is an embodiment which refines the file data to be analyzed based on predetermined conditions.

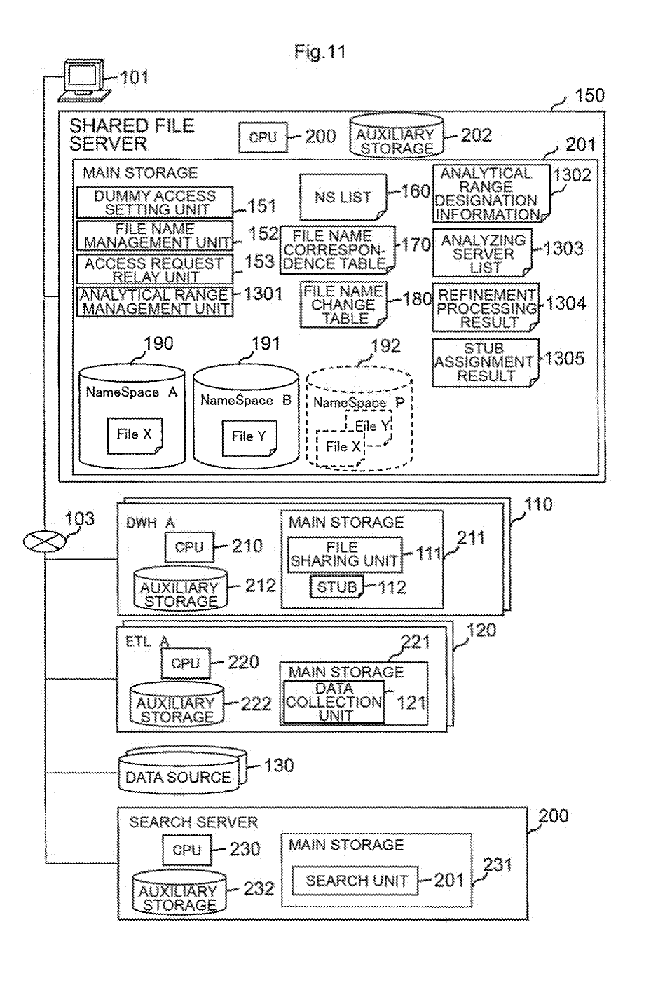

FIG. 11 shows a system configuration of the computer system in the second embodiment. Note that, in the ensuing explanation, a configuration of the computer system in the second embodiment that is the same as the configuration of the computer system in the first embodiment is given the same reference numeral and the detailed explanation thereof is omitted, and only the different points will be explained in detail.

With the second embodiment, in addition to the computer system in the first embodiment, a search server 200 is newly provided. The search server 200 receives a search refinement request of the file data from the client 101, and performs the search refinement of file data based on designated conditions. The search server 200 is configured from a CPU 230, a main storage 231 and an auxiliary storage 232, and includes a search unit 201 through coordination with the programs stored in the CPU 230 and the main storage 231.

The shared file server 150 additionally realizes an analytical range management unit 1301 through coordination with the CPU 200 and programs. Moreover, the shared file server 150 stores analytical range designation information 1302, an analyzing server list 1303, a refinement processing result 1304 and a stub assignment result 1305. The analytical range management unit 1301 manages the file data to be analyzed. The analytical range management unit 1301 sends a file search refinement request to the shared file server 150 according to the conditions described in the analytical range designation information 1302 designating the analytical range.

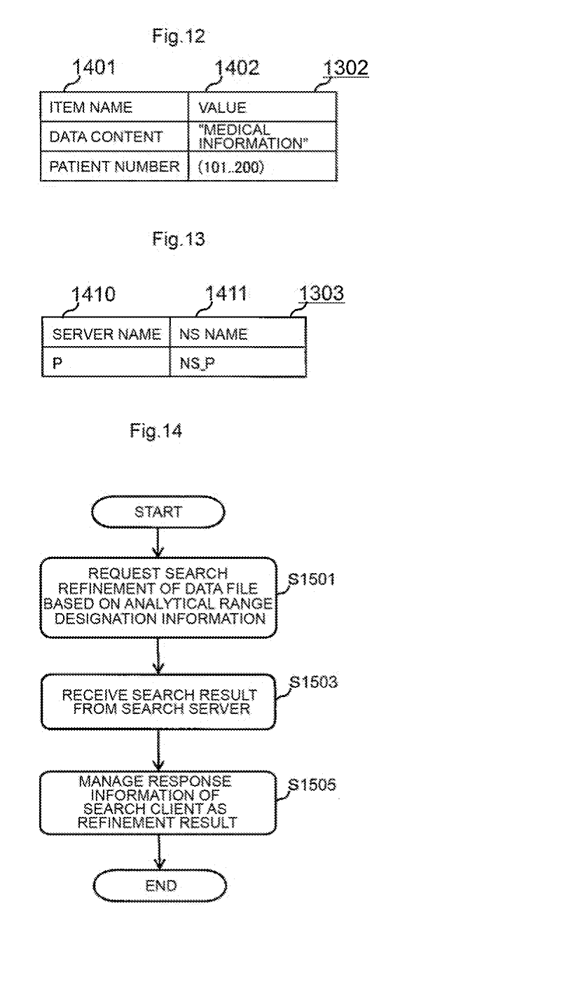

FIG. 12 shows the analytical range designation information 1302 of the shared file server 150. The analytical range management unit 1401 refers to the analytical range designation information 1402, and then sends a file data search refinement request. The analytical range designation information 1302 is configured from an item name 1401 and a value 1402. The analytical range designation information 1302 can be arbitrarily designated by the user. The item name 1401 is used by the user for designating the category of the file to be analyzed and conditions for performing the search refinement. The value 1402 shows the specific value of performing the search refinement. Here, designated is the search of file data in which the data content is “medical information” and the patient number is “101-200”.

FIG. 13 shows the analyzing server list 1303 of the shared file server 150. The analyzing server list 1303 is a table for comprehending the analyzing server 140 that is configuring the system. The analyzing server list 1303 is configured from a server name 1410 and an NS name 1411. The server name 1410 shows the name of the analyzing server. The NS name 1411 shows the NS of the analyzing server 140.

FIG. 14 shows the flow of the file data refinement processing that is executed by the analytical range management unit 1301. This processing is processing for refining the file data to be analyzed from the file data based on the analytical range designation information 1302.

Foremost, in S1501, the analytical range management unit 1301 sends a file search refinement request from the client to the search server 200 according to the analytical range designation information 1302.

Subsequently, in S1503, the analytical range management unit 1301 receives a file search result from the search server 200.

Finally, in S1505, the analytical range management unit 1301 manages the response information of the search server 200 as the refinement processing result.

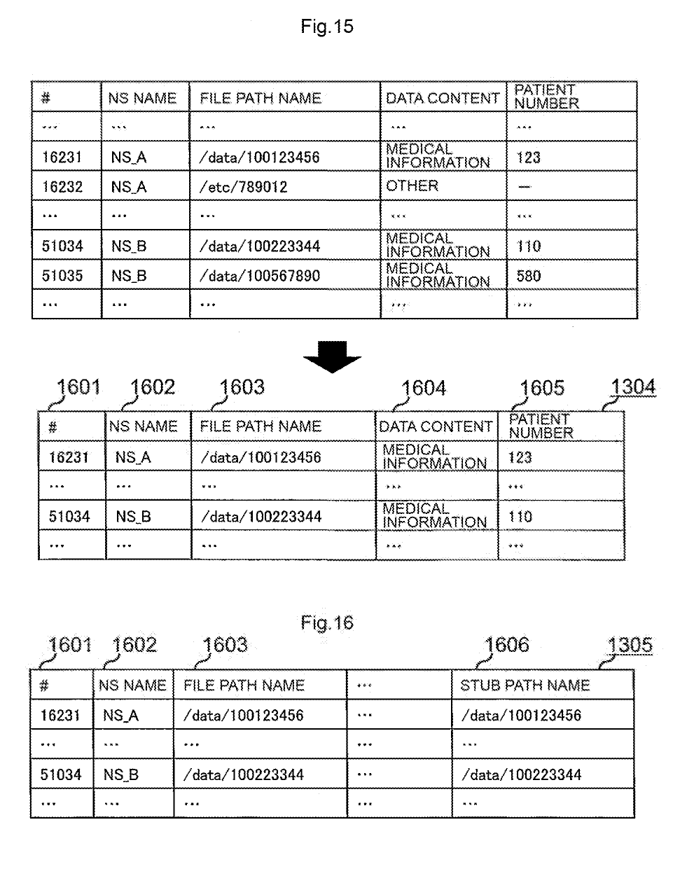

FIG. 15 shows the refinement processing result 1304 from performing file data refinement processing based on the analytical range designation information 1302 from the file data list before the file refinement processing. FIG. 15 shows the result of refining file data in which the data content is “medical information” and the patient number is “101 to 200” based on the analytical range designation information (FIG. 14A) from the file data list before the file refinement processing. Moreover, FIG. 16 shows the stub assignment result 1305. The stub assignment result 1305 is data to which is assigned the stub path name 1606 for accessing the file data of the refinement processing result 1304.

The second embodiment was explained above. According to this embodiment, it is possible to efficiently access the requested file data from a large amount of file data by designating the analytical range of the file data and performing file data refinement, and assigning a stub to the refinement processing result.

### Third Embodiment

The third embodiment of the computer system to which the present invention is applied is now explained. The third embodiment is an embodiment which balances the server load from the load information of the respective servers.

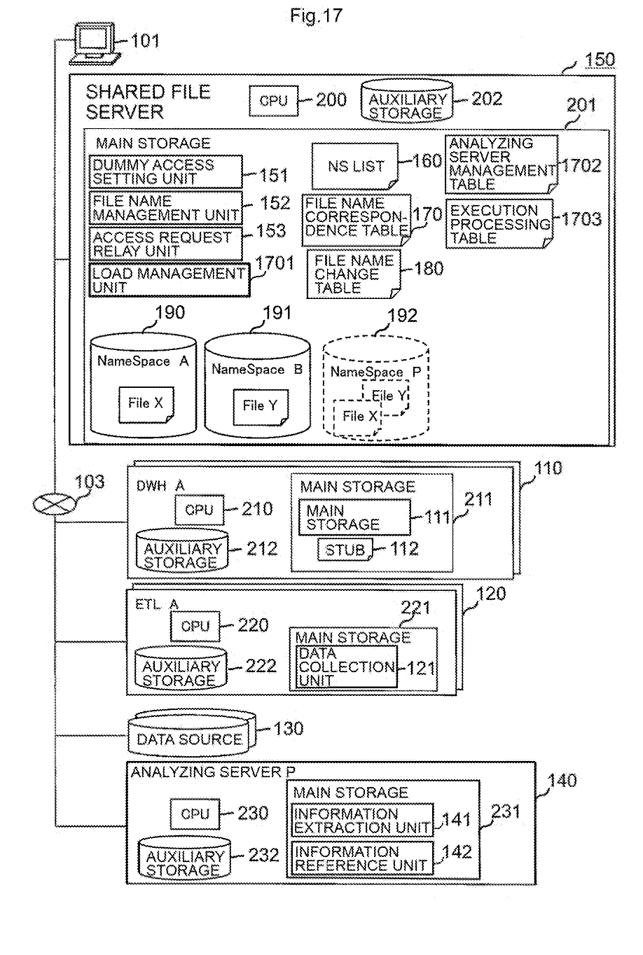

FIG. 17 shows a system configuration of the computer system in the third embodiment. Note that, in the ensuing explanation, a configuration of the computer system in the third embodiment that is the same as the configuration of the computer system in the first embodiment is given the same reference numeral and the detailed explanation thereof is omitted, and only the different points will be explained in detail.

With the third embodiment, in addition to the computer system in the first embodiment, the shared file server 150 additionally includes a load management unit 1701 through coordination with the CPU 200 and programs. The load management unit 1701 manages the load of the respective servers based on the analyzing server management table 1702, and sends a request to the dummy access setting unit 151 for relocating the stub 112 based on the execution processing table 1703.

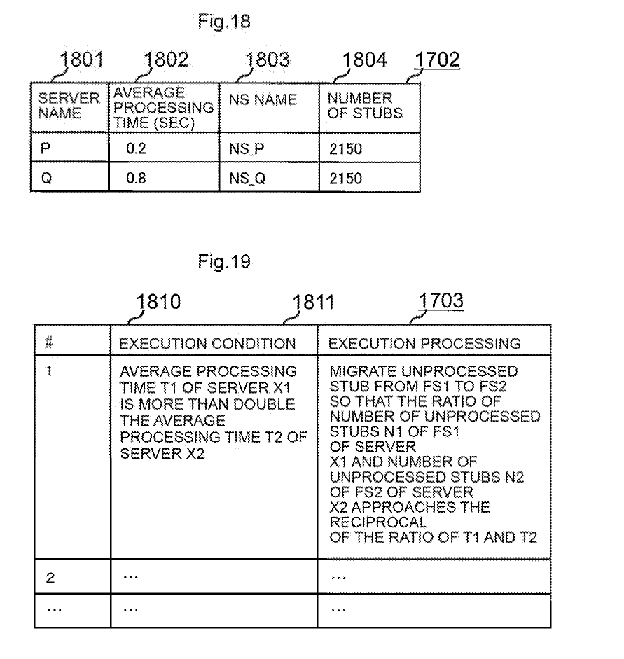

FIG. 18 shows the analyzing server management table 1702 of the shared file server 150. The analyzing server management table 1702 is configured from at least a server name 1801, an average processing time 1802, an NS name 1803 and a stub number 1804. The server name 1801 shows the name of the server configuring the computer system. The average processing time 1802 shows the average response time from receiving the analysis request from the client to returning the respective processing results from the respective servers. The NS name 1803 shows the name of the name space corresponding to the server. The stub number 1804 shows the number of stubs of the respective servers.

FIG. 19 shows the execution processing table 1703 of the shared file server 150. The load management unit 1701 refers to the execution processing table 1703, and performs the execution processing corresponding to the respective execution conditions. The execution processing table 1703 is configured at least from an execution condition 1810 and execution processing 1811. The execution condition 1810 shows the conditions for the respective servers to execute the processing. The execution processing 1811 instructs the execution processing corresponding to the respective execution conditions.

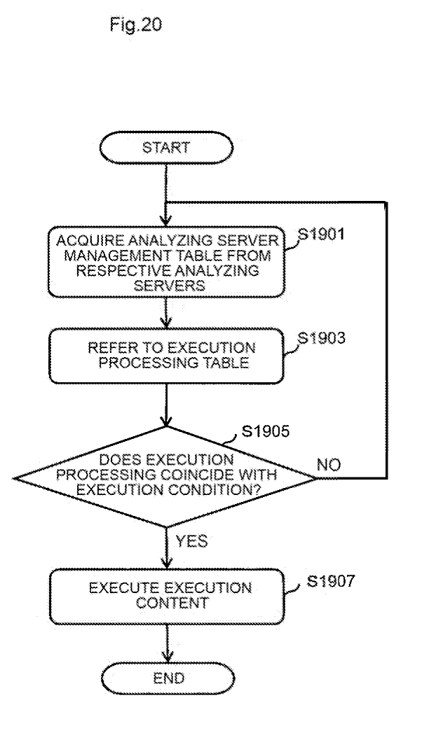

FIG. 20 shows the flow of the load redistribution processing that is executed by the load management unit 1701. This processing is processing for relocating the stub information according to the load status of the server.

Foremost, in S1901, the load management unit 1701 acquires the analyzing server management table 1702 from the respective servers.

Subsequently, in S1903, the load management unit 1701 refers to the execution processing table 1703.

Subsequently, in S1905, whether there is an analyzing server in which the execution condition and the condition coincide as a result of referring to the execution processing table 1703 is determined.

When there is an analyzing server in which the conditions coincide (S1905: Yes), in S1907, the execution contents corresponding to the execution conditions of the analyzing server management table are executed. When there is an analyzing server 140 in which the conditions coincide (S1905: No), the routine returns to S1901.

The third embodiment was explained above. According to this embodiment, the load of the server can be balanced by managing the load information such as the average processing time of the respective servers and performing execution processing that is suitable for the load status of the server.

Modes for implementing the present invention have been explained above, but the present invention is not limited to these examples, and various configurations and operations may be applied to the extent that the gist of the present invention is not changed.

Moreover, the respective functional units in the embodiments were explained as examples that are realized through the coordination of programs and the CPU, but a part of the whole thereof may also be realized as hardware.

In addition, the information that is managed in the form of various table formats in the embodiments is not limited to a table format. Moreover, various types of information may also be displayed on the operation screen of the client.

Note that the programs for realizing the respective functional units in the embodiments may be stored in an electronic and/or magnetic non-temporary recording medium.

### Reference Signs List

101 . . . client, 110 . . . DWH, 120 . . . ETL, 130 . . . data source, 140 . . . analyzing server, 150 . . . shared file server, 200 . . . search server

1. A computer including a plurality of first name spaces to which an access path to data stored in a storage area is assigned, and a name space to which a path corresponding to the access path is assigned and which is different from the first name spaces,
wherein the computer comprises a control unit for changing, when the access paths generated in different first name spaces are the same, the corresponding paths which correspond to the same access paths into mutually different paths.

2. The computer according to claim 1,
wherein the computer includes a correspondence table for managing the access paths and change information for changing the access paths, and
wherein the control unit refers to the change information and changes the corresponding paths into different paths.

3. The computer according to claim 2,
wherein the computer includes data designation information for designating data to be analyzed from the data, and
wherein the control unit assigns the corresponding paths to a data designation result designated based on the data designation information.

4. The computer according to claim 2,
wherein the computer is coupled to a plurality of other computers including the storage area, and
wherein the control unit manages load information of each of the other computers, and sorts the access paths according to an execution content corresponding to the load information.

5. The computer according to claim 2,
wherein a path corresponding to the access path is a stub path.

6. A data access management method of a computer including a plurality of first name spaces to which an access path to data stored in a storage area is assigned, and a name space to which a path corresponding to the access path is assigned and which is different from the first name spaces,
wherein the computer changes, when the access paths generated in different first name spaces are the same, the corresponding paths which correspond to the same access paths into mutually different paths.

7. The data access management method according to claim 6,
wherein the computer includes a correspondence table for managing the access paths and change information for changing the access paths, and
refers to the change information and changes the corresponding paths into different paths.

8. The data access management method according to claim 7,
wherein the computer includes data designation information for designating data to be analyzed from the data, and
assigns the corresponding paths to a data designation result designated based on the data designation information.

9. The data access management method according to claim 7,
wherein the computer is coupled to a plurality of other computers including the storage area, and
manages load information of each of the other computers, and sorts the access paths according to an execution content corresponding to the load information.

10. The data access management method according to claim 7,
wherein a path corresponding to the access path is a stub path.

11. A computer-readable non-temporary recording medium storing a program for causing a computer including a plurality of first name spaces to which an access path to data stored in a storage area is assigned, and a name space to which a path corresponding to the access path is assigned and which is different from the first name spaces, to execute:
a step of changing, when the access paths generated in different first name spaces are the same, the corresponding paths which correspond to the same access paths into mutually different paths.
